(19) United States
(12) Patent Application Publication
(10) Pub. No.: US 2013/0056147 A1
(43) Pub. Date: Mar. 7, 2013

(54) METHOD FOR LAMINATING A FLEXIBLE MATERIAL LAYER ONTO A SUBSTRATE HAVING A THREE-DIMENSIONAL CONTOUR AND DEVICE FOR THE SAME

(71) Applicant: Josef Aussermeier, Neumarkt-Sankt Veit (DE)

(72) Inventor: Josef Aussermeier, Neumarkt-Sankt Veit (DE)

(73) Assignee: LISA DRAXLMAIER GMBH, VILSBIBURG (DE)

(21) Appl. No.: 13/582,818

(22) PCT Filed: Mar. 10, 2011
(86) PCT No.: PCT/EP11/53603

§ 371 Date: Nov. 16, 2012

(30) Foreign Application Priority Data
Mar. 11, 2010 (DE) 10 2010 002766.9

(51) Int. Cl. B32B 37/06

(52) U.S. Cl. 156/275.7; 156/379.6

(57) ABSTRACT

A method is provided for laminating a flexible material layer having an upper face and a lower face onto a dimensionally stable substrate having a three-dimensional surface contour. The method comprises providing the dimensionally stable substrate, placing the lower face of the flexible material layer onto the surface contour of the dimensionally stable substrate, wherein a thermally activatable adhesive is applied to the lower face of the flexible material layer and/or the surface contour of the dimensionally stable substrate, irradiating the upper face of the applied flexible material layer with NIR radiation to activate the adhesive, and pressing the flexible material layer and the dimensionally stable substrate together after and/or during the activation of the adhesive. A device is provided for carrying out the method.

The present invention relates to a method for producing components that can be used in the interior of land vehicles, watercraft and aircraft, and in particular components for the interior of motor vehicles. These include, purely by way of example, cladding parts in the region of the doors, instrument panels, glove compartments and center consoles. In particular, the present invention relates to a method for laminating a flexible material layer having an upper face and a lower face onto a dimensionally stable substrate having a three-dimensional surface contour and a device for the same.

In the prior art, for the production of substrates laminated with a flexible material layer, a distinction is drawn primarily between what is known as vacuum laminating (also referred to as film laminating) and what is known as press laminating.

In vacuum laminating, plastic films, as a flexible material layer, are usually laminated onto substrates by the application of a vacuum. An adhesive applied to the substrate and/or to the flexible material layer is used for the joint between the substrate and the flexible material layer.

Press laminating is generally used for processing flexible material layers which are either unsuitable for vacuum processes, such as textiles, or which cannot be stretched or which can only be stretched to a limited extent, such as leather or synthetic leather. In this case, the substrate and the flexible material layer which are inserted in the die are pressed together or joined in a predefined pressing gap. In the case of this method, joining of the elements is achieved by means of an adhesive applied to the substrate and/or to the flexible material layer.

In many cases, a thermally activatable adhesive which has previously been applied to one or both elements is used for joining the two elements. This adhesive must be activated before or during the laminating operation.

This can be effected by heating the laminating dies or their mold halves such that the adhesive in the joint between the substrate and the flexible material layer is activated as a result of the substrate and the flexible material layer being in contact with the heated mold. The heating in this case is effected by simultaneous heating of the substrate and the flexible material layer. However, it must be taken into account, particularly if sensitive materials are used, that arbitrarily high temperatures cannot be applied via the mold halves.

Alternatively, it is known practice to heat the adhesive layer before the substrate and flexible material layer are brought together, e.g. by means of hot air or infra-red.

Further, owing to a low initial adhesion between the elements, it might be necessary for the joint temperature in the joint between the flexible material layer and the substrate to be rapidly reduced again by cooling one or both dies.

Moreover, it is known from DE 102 35 831 A1, to expose the substrate and flexible material layer, each of which is provided with a thermally activatable adhesive, to an NIR radiation field to activate the adhesive before bringing the two elements together. EP 1 280 867 B1 also describes the use of NIR radiation for activating the adhesive between two metal layers wherein the radiation is introduced into the joint between the elements in an open edge region at the side. However, so that the NIR radiation also continues from the edge regions into regions not accessible from outside, it is necessary for the two elements to have reflective properties. Moreover, continuous and uniform heating of the adhesive is not to be expected.

On one hand, the prior art referred to above has the disadvantage that activation of the adhesive prior to bringing the substrate and the flexible material layer together leads to time-consuming coordination processes with high connected loads and not easily demonstrated process reliability. On the other hand, the introduction of NIR radiation in the edge region of a joint leads to uneven heating of the adhesive and requires reflective properties of at least one of the two elements such that the application range has only limited transferability and in particular cannot be transferred easily to the area targeted in the present invention, that of joining mainly non-metallic materials.

Consequently, the object of the present invention is to create a method of the type referred to at the outset, which is less time-consuming at lower cycle times, requires only low connected loads and guarantees high process stability, and additionally to create an associated device.

This object is achieved by a method with the features of claim 1 and a device with the features of claim 8 or claim 9. Advantageous developments of the present invention may be found in the dependent claims.

The present invention is based on the idea of activating the adhesive in the joint between the dimensionally stable substrate and the flexible material layer by means of NIR (near infra-red) radiation, said radiation being introduced through the flexible material layer into the joint.

Accordingly, the present invention proposes a method for laminating a flexible material layer onto a dimensionally stable substrate. The flexible material layer has an upper face and a lower face. Both faces may be configured identically. Alternatively, the flexible material layer may have a good face and a bad face, wherein the good face is the upper face and the bad face is the lower face. The latter is particularly the case when laminating decor materials onto a dimensionally stable substrate, where the upper face of said materials forms a visible face in the subsequent component, said visible face being discernible by an observer in the end product, e.g. the fitted cladding part in the motor vehicle. The dimensionally stable substrate is mainly formed from synthetic material, in particular injection molded material. It has a three-dimensional surface contour. This means that its surface which later carries the flexible material layer does not lie in one plane but is a three-dimensionally curved area. The method comprises the steps of providing the dimensionally stable substrate and applying the lower face of the flexible material layer onto the surface contour of the dimensionally stable substrate. Beforehand, in a separate process step, a thermally activatable adhesive is applied to the lower face of the flexible material layer and/or the surface contour of the dimensionally stable substrate. Any known methods, such as a spray application, may be used for this. The thermally activatable adhesive may be a hot-melt or thermally activatable dispersion adhesive. The present invention proposes the use of NIR (near infra-red) radiation to activate the adhesive. In this case, near infra-red lies in the wavelength range from 780 nm to 3000 nm. This irradiation is aimed at the upper face of the applied flexible material layer. Surprisingly, it has emerged that, even when using opaque flexible material layers, the NIR radiation heats the adhesive in the joint between the flexible material layer and the dimensionally stable substrate, i.e. between the upper face and the surface contour, through the flexible material layer and thus activates it. Depending on the composition of the flexible material layer and its transparency, it may be necessary to adhere to certain maximum thicknesses perpendicular to the upper and lower face. In this case, the layer thicknesses of the flexible material layer are preferably below 2.0 nm. Minimal layer thicknesses when using special films start at 0.2 nm. Particularly when using leather (real leather) and synthetic leather, layer thicknesses below 1.4 nm are advantageous. Moreover, the method according to the invention also comprises pressing the flexible material layer and the dimensionally stable substrate together. This may take place after and/or during the activation of the adhesive, i.e. during irradiation with the NIR radiation. Preferably, however, the pressing together takes place before the irradiation such that the flexible material layer and the substrate are already fixed in an accurate position without being able to move relative to each other. By means of the embodiment according to the invention, a method is created which can be performed reliably with low cycle times and without high coordination processes.

The present invention is used especially preferably in a press laminating process wherein pressing together of the flexible material layer and the dimensionally stable substrate is performed by closing a first mold half holding the dimensionally stable substrate and a second contour-giving mold half of a press laminating die. In this case, the second contour-giving mold half has a negative contour of the finished component composed of dimensionally stable substrate and flexible material layer, e.g. decor. To be able to apply the irradiation to the upper face of the applied material layer, the second mold half is at least partially transparent for the NIR radiation such that the radiation can penetrate unobstructed through the second mold half. In this case, the second mold half may be formed of glass, Plexiglas or other NIR-transparent materials.

Moreover, it is advantageous in the method according to the invention to provide cooling once the temperature in the joint between the upper face of the flexible material layer and the surface contour of the substrate has reached the adhesive's activation temperature. This may take place immediately after the desired joint temperature is reached since cooling and heating are effected by means of different media. As a result, the overall process time can be reduced and energy savings can be achieved during cooling and heating. According to an especially preferred embodiment and during implementation in a press laminating process, it is advantageous to cool at least the second mold half and to use an NIR-transparent coolant for this. It may additionally be advantageous to cool the first mold half. During use in a vacuum laminating process, the mold half holding the dimensionally stable substrate or a corresponding support may preferably be cooled in order to effect cooling down after reaching the joint temperature.

As has already been mentioned above, the present invention may also be used within the scope of a vacuum laminating process wherein pressing together of the flexible material layer and the dimensionally stable substrate is effected by means of a film protruding around the periphery of the flexible material layer's upper face. This film is pulled towards the upper face of the applied flexible material layer in the direction of the substrate by means of a vacuum. For this, the flexible material layer must be vacuum-capable to a degree. Recesses by means of which the vacuum can be applied may be provided in the substrate. In this embodiment, it is preferable for the film to be at least partially NIR-transparent and for the irradiation to be effected through the film onto the upper face of the applied flexible material layer. However, if the film is molded sufficiently thin, it would also be conceivable to use non-NIR-transparent films. Furthermore, it is preferable in this embodiment for a support holding the dimensionally stable substrate to be cooled in order, after reaching of the joint temperature as a result of NIR irradiation, to bring about a rapid reduction of the joint temperature in order to keep the cycle times short (see above).

As was also mentioned at the outset, it is preferable for the flexible material layer to be essentially impervious to light, i.e. it is neither transparent nor translucent. Rather it is opaque.

Purely by way of example, leather, synthetic leather, non-transparent plastic films, textiles, non-woven fabrics, knitted fabrics, etc. are mentioned here as preferred materials.

In the case of interior parts for vehicles, in particular motor vehicles, intermediate layers, e.g. a haptic layer in the form of a spacer layer, e.g. a spacer fabric, are frequently provided between a decor layer and the substrate. In order to use the method according to the invention advantageously for such parts as well, it is preferable to first laminate the spacer layer onto the substrate as a flexible material layer according to the method described above. Subsequently and in a next work step, it is preferable to apply a further flexible material layer (the decor) to the upper face of the material layer (spacer layer) already laminated. This may likewise be carried out using the method according to the invention, for which purpose a further flexible material layer (decor layer) having an upper face and a lower face is applied to the flexible material layer's upper face once said flexible material layer has been laminated onto the dimensionally stable substrate. In this case, a thermally activatable adhesive is only applied to the lower face of the further flexible material layer. Then the method described above is repeated, wherein the adhesive joint this time between the upper face of the flexible material layer and the lower face of the further flexible material layer is heated.

In addition to the method, the present invention also proposes a press laminating device and a vacuum laminating device in order to carry out the process referred to above.

For this, the press laminating device comprises a first mold half holding the dimensionally stable substrate and a second contour-giving mold half such as have already been mentioned above. Furthermore, an NIR irradiation unit is provided and the second mold half is at least partially transparent such that the irradiation from the NIR irradiation unit can pass through the second mold half. According to an especially preferred embodiment, the second mold half may be cooled, for which purpose a transparent cooling medium is used.

In vacuum lamination, a support is provided for the dimensionally stable substrate. According to a preferred embodiment, this may be cooled. In addition, the device includes a film protruding around the periphery of the flexible material layer's upper face as well as a vacuum unit which is designed so that the substrate pulls the film towards the upper face of the flexible material layer in the direction of the substrate. Here too an NIR irradiation unit is provided and the film is at least partially NIR-transparent such that the irradiation can be applied through the film onto the upper face of the flexible material layer.

It is especially preferable not to heat the mold halves or the support. Heating up the thermally activatable adhesive in the joint takes place in the invention exclusively by means of the NIR irradiation.

Further features and advantages of the present invention, which may be implemented singly or in combination with one or a plurality of the features referred to above, insofar as the features do not interfere with each other, are apparent from the following description of a preferred embodiment. This description is provided with reference to the associated drawings which show:

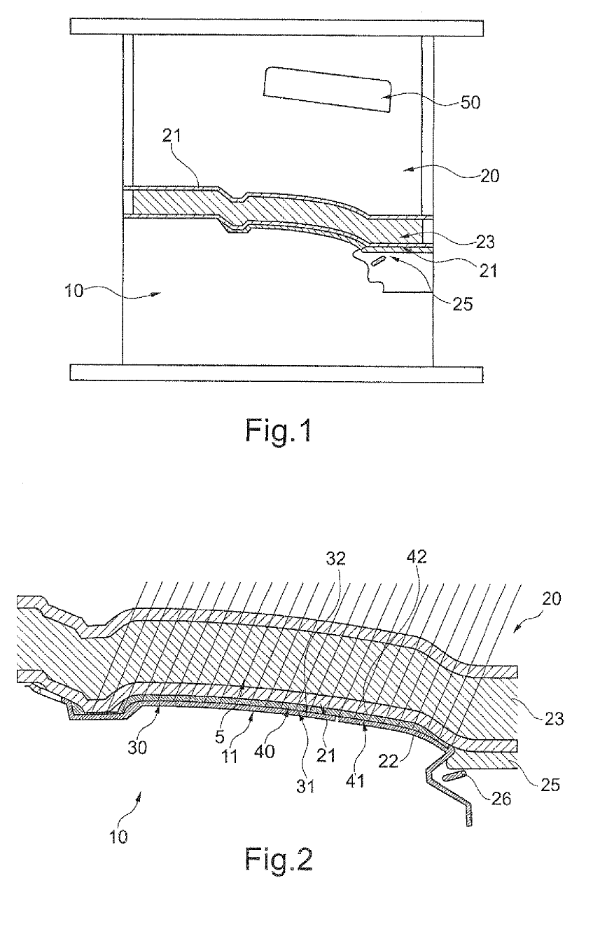

FIG. 1 a schematic view of a press laminating die according to an embodiment of the present invention; and

FIG. 2 a detail from FIG. 1 on an enlarged scale during activated NIR irradiation.

It goes without saying that the embodiment described below is merely an example and there are many conceivable variations and modifications which are easily obvious to the person skilled in the art. Also, purely by way of example, the present invention is explained on the basis of a press laminating process and press laminating die but may also be implemented within the scope of a vacuum laminating process.

The press laminating die illustrated in FIG. 1 is composed of a bottom die 10, the lower die half, and a top die 20, the upper die half. Bottom die 10 may be a die half made of aluminum. Bottom die half 10 is designed to accommodate a dimensionally stable substrate 30 (FIG. 2).

Bottom die 10 may be cooled if necessary but is unheated. Top die 20 comprises a die shell 21. Shell 21 has a shape-giving inner contour 22. A pressing gap is defined between shaping inner contour 22 and a surface 11 of bottom die 10 on which substrate 30 rests. Die shell 21 of top die 20 is formed from an NIR-transparent material, e.g. glass, Plexiglas, etc. Cooling channels 23 through which an NIR-transparent coolant flows, which are represented in the figures by hatching, are formed in tool shell 21. This may, for example, be water or silicone oil. Die shell 21 is also unheated.

An NIR emitter 50 is arranged above die shell 21. This may be formed from a plurality of conventional halogen emitters, e.g. by the Heraeus company. NIR emitter 50 may preferably be activated and deactivated intermittently, i.e. discontinuously, in order to apply an intermittent NIR radiation. The radiation direction of NIR emitter 50 is oriented at the same time preferably perpendicular to a majority, i.e. more than half of the component to be irradiated (see FIG. 2), particularly of upper face 41 of flexible material layer 40. The direction of the NIR radiation is identified in FIG. 2 by S.

Dimensionally stable substrate 30 illustrated in FIG. 2 is preferably a synthetic substrate and preferably injection molded. It has a surface 31. This surface 31 is three-dimensionally curved such that a surface contour is formed. Face 32 of the substrate which opposes surface contour 31 rests on upper face 11 of bottom die 10. As can best be seen from FIG. 2, flexible material layer 40 which, according to the exemplary embodiment, is a decor layer, preferably of real leather or synthetic leather, rests with its lower face 41 or back side on surface contour 31 of substrate 30 while upper face 42 of inner contour 22 faces towards die shell 21. A thermally activatable adhesive which is not illustrated is provided in the joint between surface contour 31 and lower face 41. This may be applied to lower face 41 and/or surface contour 31. The adhesive may be a hot melt or thermally activatable dispersion adhesive. The activation temperature may lie within a range between 50° C. and 200° C. For a hot melt it is preferably approx. 70° C. For a dispersion adhesive it is preferably approx. 55° C.

Moreover, the device illustrated includes a fold over slider 25 for folding over a portion of flexible material layer 40 protruding over dimensionally stable substrate 30 in the substrate's marginal region. A further heating unit 26 which may be of a conventional type, i.e. infra-red or hot air, may be provided in order to activate the thermally activatable adhesive in this region also. Alternatively, it is also conceivable to use an NIR emitter here.

The method according to the invention is explained below based on the device illustrated in FIGS. 1 and 2.

First of all, dimensionally stable substrate 31 with flexible material layer 40 pre-fixed and already aligned on it is placed in bottom die 10. At this stage, the press laminating die is in an opened state unlike the die in FIG. 1. Then the press laminating die closes in that die halves 10 and 20 move towards each other until they are in the position shown in FIGS. 1 and 2 in which flexible material layer 40 and dimensionally stable substrate 30 are pressed together. When the mold halves are closed, NIR emitter 50 is activated in order to emit radiation S in the direction of upper face 42 of flexible material layer 40. In the process, NIR radiation S passes into cooling channels 23 through NIR-transparent die shell 21 as well as the NIR-transparent coolant. Moreover, the NIR radiation can surprisingly also penetrate the flexible material layer without heating it significantly. This is mainly due to the composition of the flexible material layer and its low layer thickness. Thus, for example, leather, synthetic leather, plastic films, textiles, knitted fabrics and non-woven fabrics having a layer thickness of less than 2.0 mm can be used. A minimum layer thickness of 0.2 mm is conceivable for films.

As a result, NIR radiation S acts directly in the adhesive joint between surface contour 31 and lower face 41 in order to bring the thermally activatable adhesive (not illustrated) to the desired activation temperature. In this case, the irradiation is preferably effected intermittently, i.e. cycled, such that the desired joint temperature can be set as accurately as possible.

Once the adhesive has reached the desired joint temperature, top die half 21 is cooled by means of the transparent coolant which flows through cooling channels 23. If necessary, bottom die 10 may also be cooled. As a result, the joint temperature can quickly be reduced again directly after optimum activation of the adhesive. The heating time is shortened by using NIR emitters. Subsequent to this, cooling can take place immediately as heating is not effected via the die halves as in the prior art. The overall process time can be shortened as a result. Energy savings also emerge during both heating and cooling in addition to an increase in process stability. Heating of possibly sensitive flexible material layers can also be minimized thus protecting their surface.

1. A method for laminating a flexible material layer having an upper face and a lower face onto a dimensionally stable substrate having a three-dimensional surface contour, the method comprising:
providing the dimensionally stable substrate;
placing the lower face of the flexible material layer onto the surface contour of the dimensionally stable substrate, wherein a thermally activatable adhesive is applied to the lower face of the flexible material layer and/or the surface contour of the dimensionally stable substrate;
irradiating the upper face of the applied flexible material layer with NIR radiation to activate the adhesive; and
pressing the flexible material layer and the dimensionally stable substrate together after and/or during the activation of the adhesive.

2. The method according to claim 1, wherein the pressing together of the flexible material layer and the dimensionally stable substrate is effected by closing of a first mold half holding the dimensionally stable substrate and a second contour-giving mold half of a press laminating die, wherein the second mold half is at least partially NIR-transparent and the irradiation is effected through the second mold half onto the upper face of the applied flexible material layer.

3. The method according to claim 2, wherein the second mold half is cooled using an NIR-transparent coolant.

4. The method according to claim 1, wherein pressing together of the flexible material layer and the dimensionally stable substrate is effected by a film protruding around the periphery of the upper face of the flexible material layer the film being pulled by a vacuum towards the upper face of the applied flexible material in the direction of the substrate, wherein the film is at least partially NIR-transparent and the irradiation is effected through the film onto the upper face of the applied flexible material layer.

5. The method according to claim 1, wherein the flexible material layer is essentially optically opaque.

6. The method according to claim 5, wherein the flexible material layer is composed of leather, synthetic leather, a plastic film, a textile, a non-woven fabric or a knitted fabric.

7. The method according to claim 1, further comprising:
placing a second flexible material layer having an upper face and a lower face onto the upper face of the flexible material layer after laminating the flexible material layer onto the dimensionally stable substrate, wherein a thermally activatable adhesive is applied to the lower face of the second flexible material layer;
irradiating the upper face of the applied second flexible material layer with NIR radiation to activate the adhesive; and
pressing the second flexible material layer together with the composite of flexible material layer and dimensionally stable substrate after and/or during the activation of the adhesive, wherein the flexible material layer is a haptic layer and the second flexible material layer is a decor layer.

8. A device for laminating a flexible material layer having an upper face and a lower face onto a dimensionally stable substrate with a three-dimensional surface contour, the device comprising:
a first mold half to hold the dimensionally stable substrate,
a second contour-giving mold half, wherein the second mold half is at least partially NIR-transparent, and
an NIR irradiation unit to irradiate the upper face of the flexible material layer through the second mold half.

9. A device for laminating a flexible material layer having an upper face and a lower face onto a dimensionally stable substrate with a three-dimensional surface contour, the device comprising:
a support for the dimensionally stable substrate,
a film protruding around the periphery of the upper face of the flexible material layer,
a vacuum unit to pull the film by way of the substrate towards the upper face of the applied flexible material layer in the direction of the substrate, wherein the film is at least partially NIR-transparent, and
an NIR irradiation unit to irradiate the upper face of the flexible material layer through the film.

10. The device according to claim 9, wherein the mold halves the support is unheated.

11. The device according to claim 8, wherein the first and second mold halves are unheated.
